(19) United States
(12) Patent Application Publication
(10) Pub. No.: US 2008/0150749 A1
(43) Pub. Date: Jun. 26, 2008

(54) WIRELESS CONTROL SYSTEM FOR CONTROLLING LINEAR ACTUATORS

(76) Inventor: TAI-HUNG LIN, Taichung (TW)

Correspondence Address: Dr. BANGER SHIA, 102 Lindencrest Ct., Sugar Land, TX, 77479-5201, US

(21) Appl. No.: 11/614,890

(22) Filed: Dec. 21, 2006

(51) Int. Cl. G08C 19/00; G05B 11/01

(52) U.S. Cl. 340/825.72; 340/825

(57) ABSTRACT

A wireless control system for controlling linear actuators comprises at least: a plurality of linear actuators, a plurality of control equipments, and at least one wireless controller. The respective linear actuators are assembled on an automatic machine after being connected to a control equipment. The wireless controller and the respective control equipments are provided with a two-way sequence transmitting and receiving assembly which complies with IEEE 802. The wireless control system avoids the use of control boxes and wires while increasing the additional value. Further, the two-way sequence transmitting and receiving assembly ensures the operation status of between the wireless controller and the respective linear actuators, and prevents the direction problem of the wireless control.

### BACKGROUND OF THE INVENTION

1. Field of the Invention

The present invention relates to a wireless control system, and more particularly to a wireless control system for controlling linear actuators, which avoids the use of control boxes and wires while increasing the additional value.

2. Description of the Prior Art

Nowadays, linear transmission device is used more and more widely in modern industries, and the linear transmission device generally includes linear guideway and ball screw. In addition to the effect of high precision, the linear transmission device also has the advantages of low frictional loss, high energy conversion ratio, low noise and high rigidity. Hence, it is self-evident that the linear transmission means is very important to various industrial mechanisms.

Various existing automatic feed machines must be provided with many wireless control actuators, for example, the automatic lifting sickbed in a medical facility, the massage chair in the recreational equipment, the electric door in traffic facility, the electric chair in a car, the automatic smoke exhaust door and window in a factory, and etc. The various aforementioned automatic feed machines all require a longer operation distance, a large installation space and a better operation condition. And the various existing designs also have their own disadvantages. Therefore, how to develop an improved and competitive product is the common goal that the manufactures are striving for.

Examples of the use of commonly known wireless control method for a linear device is shown in FIGS. 1 and 2, and FIG. 3 is an illustrative view of showing an infrared wireless control system.

FIG. 1 shows an automatic lifting sickbed 10 in a medical facility; FIG. 2 shows an electric chair 11; and these two conventional equipments are usually provided with a plurality of linear actuators 13 and a wireless controller 14 with an infrared transmitter 141. Each of the linear actuators 13 is connected to a control box 15 via a transmission cable 131. In the control box 15 are arranged a plurality of control equipments 151 that are connected to the linear actuators 13. A central control member 16 with an infrared receiver 161 controls the control equipments 151. The infrared receiver 161 serves to receive the signal from the infrared transmitter 141 of the wireless controller 14.

Both of the two conventional equipments as mentioned above should use infrared wireless control technique, however, this technique not only has its own problem, but also has the following common problems:

Firstly, the existence of the infrared wireless control technique facilitates distance control. However, infrared wireless control must work in a point-to-point manner, and the infrared receiver 161 must be aligned with the infrared transmitter 141 of the wireless controller 14, otherwise signal cannot be received. However, most of the users using the automatic lifting sickbed 10 and the electric chair 11 as shown in FIGS. 1 and 2 have difficulty getting about, and how to let the users aim at the signal point has become a design problem. Further, if a third person must assist in controlling, the point-to-point path of the infrared wireless control definitely cannot be satisfied simultaneously. Therefore, there are many limitations for using infrared wireless technique on linear actuator.

Second, most of the conventional linear actuator controlling equipments are provided with a plurality of linear actuators 13 that are connected to a control box 15 via a transmission cable 131. In the control box 15 are arranged a plurality of control equipments 151 that are connected to the linear actuators 13. And a central control member 16 controls the control equipments 151. However, the aforementioned techniques must arrange a control box 15 between the wireless controller 14 hold by the user and the linear actuators 13, such that not only the number of control boxes 15 is still the same, but also many problems will occur, such as the wires, the boxes, the space for receiving them, the power supply and the circuit arrangement. This is one of the problems that need to be solved urgently.

Third, the conventional control equipment for controlling the linear actuators employs the infrared receiver 161 of the central control member 16 of the control boxes 15 to receive the signal from the infrared transmitter 141 of the wireless controller 14, but is unable to let the user hold the wireless controller 14 know the condition and the position of the linear actuators 13, and as a result, the conventional control lack in design and display mode.

To effectively solve the aforementioned problems, the inventor of the present invention, on the basis of the accumulated experience and skills associated with the linear transmission field, has developed a low cost and easily controllable linear actuator control system.

### SUMMARY OF THE INVENTION

The primary objective of the present invention is to provide a wireless control system for controlling linear actuators without using control box and wire.

The secondary objective of the present invention is to provide a wireless control system for controlling linear actuators that is not restricted by the control direction.

To obtain the abovementioned objectives, a wireless control system for controlling linear actuators in accordance with the present invention comprises at least: a plurality of linear actuators, a plurality of control equipments, and at least one wireless controller. The respective linear actuators are assembled on an automatic machine after being connected to a control equipment. The wireless controller and the respective control equipments are provided with a two-way sequence transmitting and receiving assembly which complies with IEEE 802. The present invention avoids the use of control boxes and wires, thus increasing the additional value of the wireless controller. Further, the two-way sequence transmitting and receiving assembly ensures the operation status between the wireless controller and the respective linear actuators, and prevents the direction problem of the wireless control.

### BRIEF DESCRIPTION OF THE DRAWINGS

FIG. 1 shows an example of an automatic control machine;

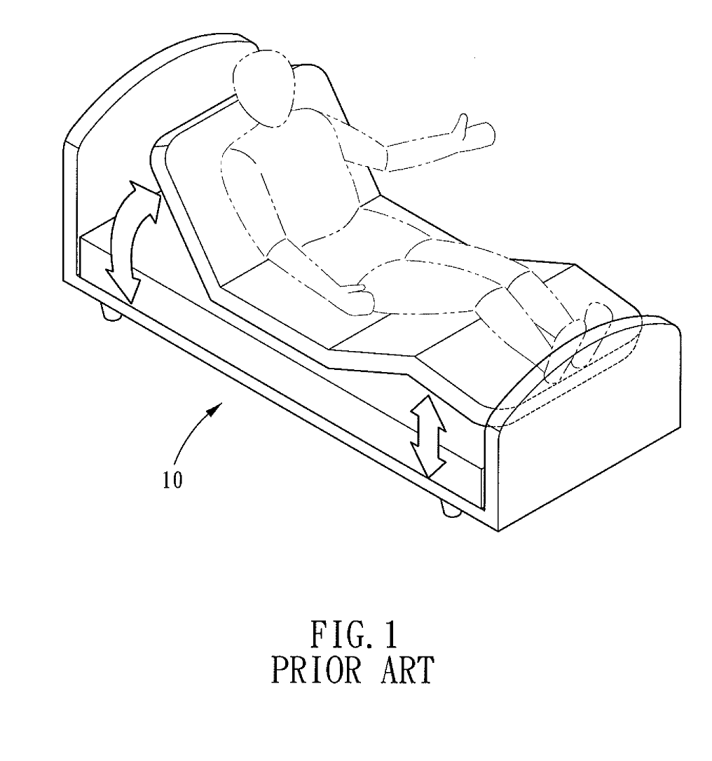

FIG. 2 shows another example of an automatic control machine;

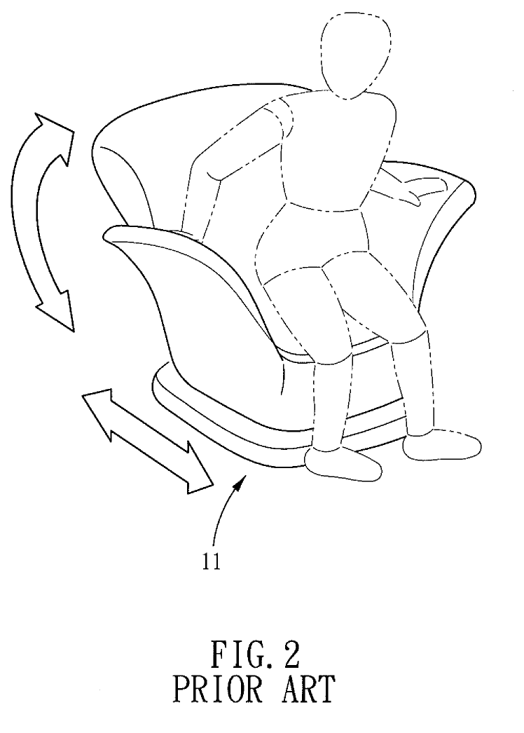

FIG. 3 is an illustrative view of showing a conventional infrared wireless control system;

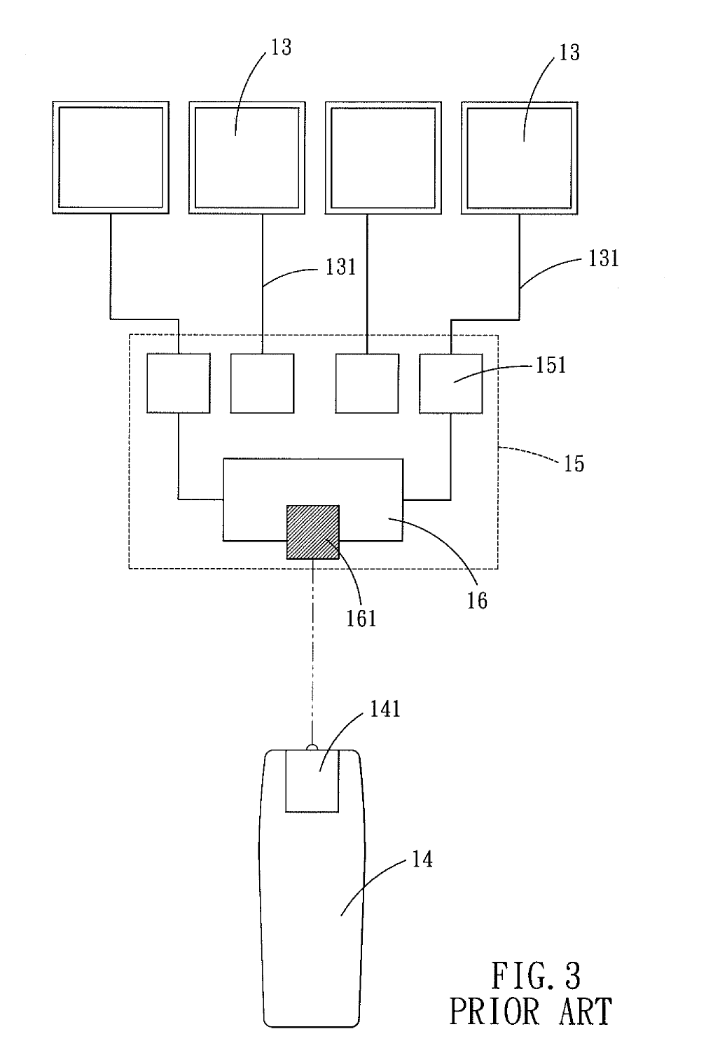

FIG. 4 is an illustrative view of showing the operation of a wireless control system for controlling linear actuators in accordance with the present invention; and

FIG. 5 is another illustrative view of showing the operation of the wireless control system for controlling linear actuators in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

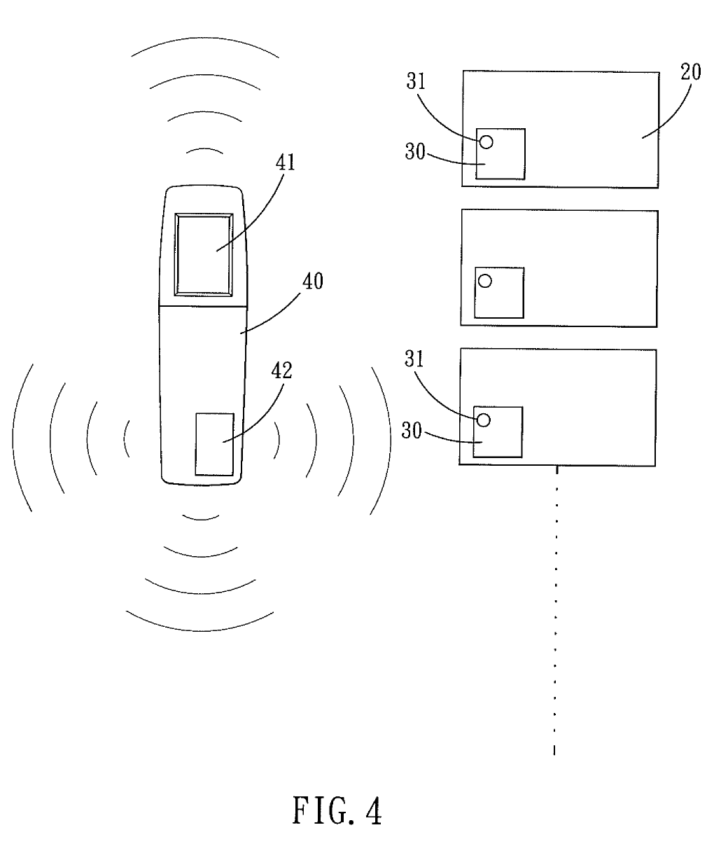

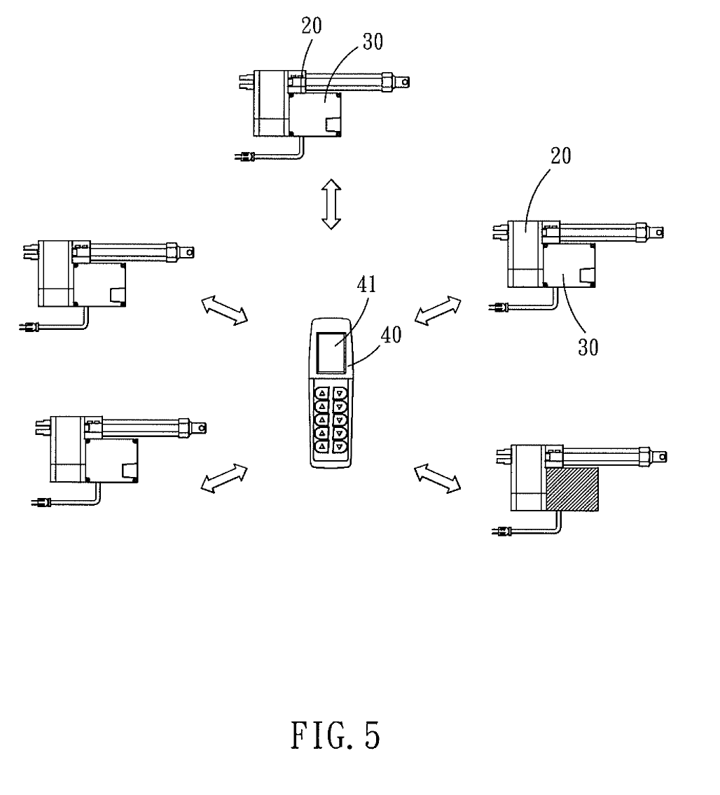

Referring to FIGS. 4 and 5, a wireless control system for controlling linear actuators in accordance with the present invention comprises: a plurality of actuators 20, a plurality of control equipments 30, and at least one wireless controller 40, which is characterized in that:

The linear actuators 20 are installed on a preset automatic control machine.

The control equipments 30 are assembled with the linear actuators 20, and each of the control equipments 30 is provided with a transmitting and receiving assembly 31 which complies with IEEE 802. The transmitting and receiving assembly 31 transmits two-way sequence signal.

The wireless controller 40 includes a display unit 41 and at least one transmitting and receiving assembly 42. The transmitting and receiving assemblies 42 and 31 transmit two-way sequence signals to each other, so that the wireless controller 40 can control the linear actuators 20.

Further, the wireless controller 40 can control a plurality of linear actuators 20 simultaneously, and the linear actuators 20 utilize the transmitting and receiving assembly 31 of the control equipments 30 to obtain the feedback on the working status.

It is to be noted that the acceptable frequency band of this embodiment is IEEE 802.15.4 (2.4 GHz) for example, and the transmitting and receiving assembly 42 and the transmitting and receiving assembly 31 of the control equipments 30 transmit two-way sequence signals (Zigbee) to each other, thus not only enabling the wireless controller 40 to control the plurality of linear actuators 20 simultaneously by the use of the plural control equipments 30, but also allowing the linear actuators 20 to utilize the transmitting and receiving assembly 31 of the control equipments 30 to obtain the feedback on the current working status. Meanwhile, the display unit 41 of the wireless controller 40 can display the operation status between them.

It is to be noted that when a distance between the wireless controller 40 and one of the control equipments 30 exceeds transmissible range, by making use of the feature of the two-way sequence signal (Zigbee), the present invention can use another control equipment 30 within the transmissible distance as a relay point, allowing the wireless controller to be connected to (to control) another control equipment via the relay point. Therefore, the present invention can increase the controllable scope without the use of control boxes and wires.

To summarize, the present invention comprises a plurality of linear actuators, a plurality of control equipments, and at least one wireless controller. The respective linear actuators are assembled on an automatic machine after being connected to a control equipment. The wireless controller and the respective control equipments are provided with a two-way sequence transmitting and receiving assembly which complies with IEEE 802. The present invention avoids the use of control boxes and wires, increases the additional value of the wireless controller. Further, the two-way sequence transmitting and receiving assembly ensures the operation status of between the wireless controller and the respective linear actuators, and prevents the direction problem of the wireless control.

While we have shown and described various embodiments in accordance with the present invention, it is clear to those skilled in the art that further embodiments may be made without departing from the scope of the present invention.

What is claimed is:

1. A wireless control system for controlling linear actuators, comprising:
a plurality of linear actuators installed on an automatic control machine;
a plurality of control equipments assembled with the linear actuators, and each of the control equipments being provided with a transmitting and receiving assembly which complies with IEEE 802, the transmitting and receiving assembly serving to transmit two-way sequence signal;
at least one wireless controller provided with a transmitting and receiving assembly, wherein the transmitting and receiving assembly of the wireless controller and the transmitting and receiving assembly of the control equipments transmit two-way sequence signals to each other, so that the wireless controller is able to control the linear actuators.

2. The wireless control system for controlling linear actuators as claimed in claim 1, wherein the wireless controller controls the plurality of linear actuators simultaneously.

3. The wireless control system for controlling linear actuators as claimed in claim 1, wherein the wireless controller uses one control equipment within transmissible distance as a relay point, thus allowing the wireless controller to be connected to another control equipment via the relay point.

4. The wireless control system for controlling linear actuators as claimed in claim 1, wherein the transmitting and receiving assembly of the wireless controller and the transmitting and receiving assembly of the control equipments transmit two-way sequence signals to each other at frequency band of IEEE 802.15.4 (2.4 GHz).

5. The wireless control system for controlling linear actuators as claimed in claim 2, wherein the transmitting and receiving assembly of the wireless controller and the transmitting and receiving assembly of the control equipments transmit two-way sequence signals to each other at frequency band of IEEE 802.15.4 (2.4 GHz).

6. The wireless control system for controlling linear actuators as claimed in claim 3, wherein the transmitting and receiving assembly of the wireless controller and the transmitting and receiving assembly of the control equipments transmit two-way sequence signals to each other at frequency band of IEEE 802.15.4 (2.4 GHz).

7. The wireless control system for controlling linear actuators as claimed in claim 1, wherein the wireless controller is provided with a display unit for displaying operation status.

8. The wireless control system for controlling linear actuators as claimed in claim 4, wherein the linear actuators utilizes the transmitting and receiving assembly of the control equipments to obtain a feedback on current working status.

9. The wireless control system for controlling linear actuators as claimed in claim 5, wherein the linear actuators utilizes the transmitting and receiving assembly of the control equipments to obtain a feedback on current working status.

10. The wireless control system for controlling linear actuators as claimed in claim 6, wherein the linear actuators utilizes the transmitting and receiving assembly of the control equipments to obtain a feedback on current working status.
